(19) United States
(12) Patent Application Publication
(10) Pub. No.: US 2008/0082820 A1
(43) Pub. Date: Apr. 3, 2008

(54) METHOD AND APPARATUS FOR DETERMINING AVAILABILITY OF A REMOTE PARTY BASED ON INTERACTION WITH COUPLED DEVICES

(75) Inventor: Carlton J. Sparrell, Marblehead, MA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/538,208

(22) Filed: Oct. 3, 2006

(51) Int. Cl. H04L 9/00

(52) U.S. Cl. 713/168

(57) ABSTRACT

A method (50) or system (10) of determining availability of a remote party can include a communication device (13, 28 or 30) enabled and authorized to monitor a remote appliance (12, 16, 18, or 19) belonging to the remote party and a processor 11 coupled to the communication device or the remote appliance. The system can monitor (53) the remote appliance for a predetermined set of activities indicative of availability or unavailability of the remote party when the communication device is attempting to communicate with the remote party, analyze (54) the predetermined set of activities, and notify (55) the communication device of the unavailability of the remote party if the predetermined set of activities match a stored set of activities. The system can prevent or enable (56) a call or an alert if the predetermined set of activities match or fail to match the stored set of activities.

### FIELD

This invention relates generally to monitoring of remote devices, and more particularly to a method and system of determining the availability of a remote user based on interactions with remote devices.

### BACKGROUND

Being interrupted with a telephone call in the middle of dinner or other typical family activity is a common annoyance many want to avoid. Furthermore, family and friends who call during such times also want to avoid such interruptions and would rather call at another time. Unfortunately, there is no easy way to prevent calls or alerts based on such activities other than leaving a phone unhooked. Unfortunately, such methods fail to predict availability or a lack thereof and also cause missed calls when there is actual availability.

One technique used with networked computer systems dating to the 1980s provided an ‘idle time’ determination. A user could ‘finger’ another user and receive information based on how long their keyboard had been idle. Another device described in U.S. Patent Publication No. 200502465588 discusses a profile based capture component that creates a user profile based on capturing keystrokes. In both instances, these are not activities that provide an indication of an engaging activity or indicative of availability. Nor do they provide a means for expressly indicating availability or a lack of availability to a potential caller.

### SUMMARY

Embodiments in accordance with the present invention can provide a method and system for determining availability of a remote party for communication by monitoring interactivity with a device used by the remote party.

In a first embodiment of the present invention, a method of determining an availability of a remote party can include the steps linking a communication device to a remote device belonging to the remote party, monitoring the remote device for a predetermined set of activities indicative of availability or unavailability of the remote party, analyzing the predetermined set of activities, and notifying the communication device of the unavailability of the remote party if the predetermined set of activities match a stored set of activities. The method can also include the step of preventing a call or an alert to the remote party if the predetermined set of activities matches the stored set of activities or enabling a call or an alert to the remote party if the predetermined set of activities failed to match the stored set of activities. The predetermined set of activities can include fast forwarding, rewinding, pausing, recording or changing channels on a set-top box or fast forwarding or rewinding or recording on a video recording device changing channels on a television tuner as examples. The predetermined set of activities can include activation of a function on the remote device implicitly indicating an unengaged user or activation of a function on the remote device explicitly indicating an engaged user. The method can further include the step of linking the communication device to the remote device for the purpose of monitoring the remote device if the communication device is authorized to monitor the remote device.

In a second embodiment of the present invention, a system of determining availability of a remote party can include a communication device enabled and authorized to monitor a remote appliance belonging to the remote party and a processor coupled to the communication device or the remote appliance. The processor can be programmed to monitor the remote appliance for a predetermined set of activities indicative of availability or unavailability of the remote party when the communication device is attempting to communicate with the remote party, analyze the predetermined set of activities, and notify the communication device of the unavailability of the remote party if the predetermined set of activities match a stored set of activities. The processor can be further programmed to prevent a call or an alert at a communication device at the remote party if the predetermined set of activities match the stored set of activities and enable a call or an alert at the remote party if the predetermined set of activities failed to match the stored set of activities. As noted above, the predetermined set of activities can include fast forwarding, rewinding, pausing, or changing channels on a set-top box or fast forwarding or rewinding on a video recording device or changing channels on a television tuner as examples. The predetermined set of activities can also be activation of a function on the remote appliance implicitly indicating an unengaged user or explicitly indicating an engaged user.

In a third embodiment of the present invention, an appliance can include a transceiver for communicating with a communication device and a processor coupled to the transceiver. The appliance can be for example a set-top box, a desktop computer, a laptop computer, a personal video recorder, a digital video recorder, a digital video player or recorder, a television tuner, or a remote controller for any of the aforementioned appliances. The processor can be programmed to monitor the remote appliance for a predetermined set of activities indicative of availability or unavailability of the remote party when the communication device is attempting to communicate with a party using the appliance, analyze the predetermined set of activities, and notify the communication device of the unavailability of the party using the appliance if the predetermined set of activities match a stored set of activities. The processor can be further programmed to instruct or otherwise prevent a call or an alert on the communication device if the predetermined set of activities match the stored set of activities and enable a call or an alert at the communication device if the predetermined set of activities failed to match the stored set of activities. As noted above, the predetermined set of activities can include fast forwarding, rewinding, pausing, or changing channels on a set-top box or fast forwarding or rewinding on a video recording device or changing channels on a television tuner. The predetermined set of activities can also include activation of a function on the appliance implicitly indicating an unengaged user or activation of a function on the appliance explicitly indicating an engaged user.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing as well as a machine readable storage for causing a machine to perform the various processes and methods disclosed herein.

### BRIEF DESCRIPTION OF THE DRAWINGS

FIG. 1 is a system for determining availability of a remote party in accordance with an embodiment of the present invention.

FIG. 2 is a flow chart illustrating a method determining availability of a remote party in accordance with an embodiment of the present invention.

FIG. 3 is another system of determining availability of a remote party in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways in various devices such as in appliances such as set-top boxes, video recording devices, stereo systems, television sets, laptop computers and desktop computers or other appliances that can provide an indication and monitor for the availability or unavailability of a user. Such embodiments provide a remote ability to determine whether someone is likely to be home and available to answer calls. Such a system in one embodiment can capture events such as remote control presses, fastforward, rewind, play, or channel presses up or down to determine if someone is watching the TV or otherwise engaged in an activity. The system can communicate to another user that has been authorized or accepted into a ‘friends and family’ group to provide notification of availability. A display (ambient display, television, or user interface device for example can indicate whether a person in a remote home is active. The local user can use that information to determine if someone is home and more likely to be available for communications. Alternatively or optionally, a remote user can explicitly indicate ‘do not call’ or more specifically indicate what type of communication they will or will not accept (e.g. currently accepting IM, but no phone calls).

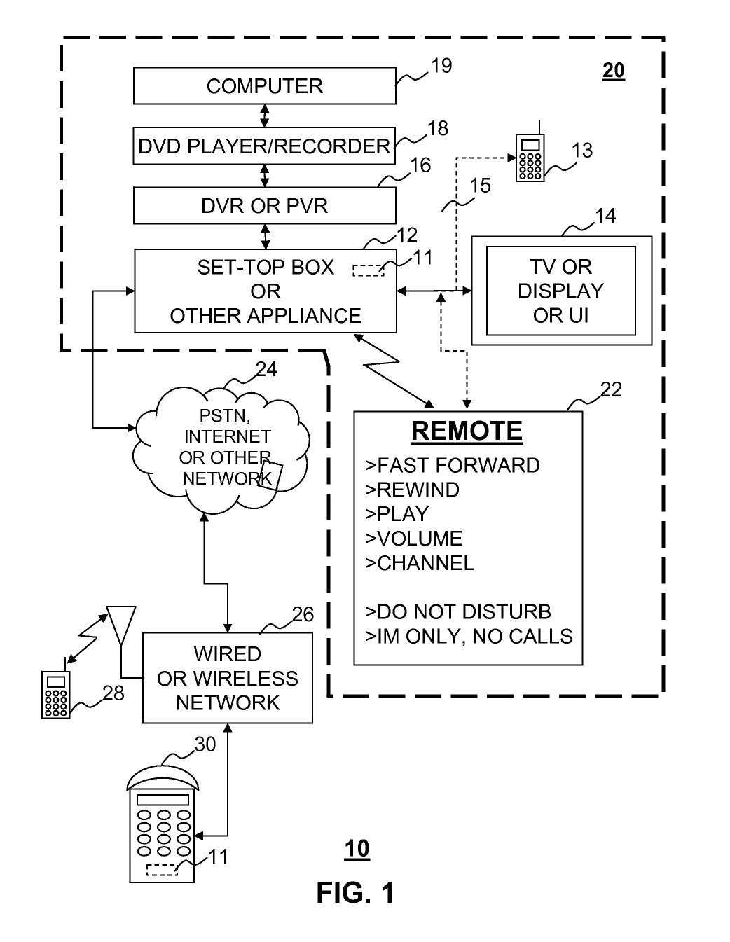

Referring to FIG. 1, a system 10 of determining availability of a remote party can include a communication device (13, 28 or 30) enabled and authorized to monitor a remote appliance (12, 16, 18, or 19) belonging to the remote party and a processor 11 coupled to the communication device or the remote appliance. In this context, “belonging to” does not necessarily mean “owned by”, but rather “associated with”, wherein the association is typically one that provides a substantial assurance that, at the time a communication with the remote party is attempted, the state of operation of the remote appliance has been determined by the remote party. For example, a nanny may be the person who can be assumed to control a particular TV, owned by her employer, during a defined set of working hours, and is therefore associated with that TV during those hours. As shown, the communication device 13 can be, for example, a cellular phone, a home cordless phone, or a wired home phone. The communication device 28 or 30 can be a cellular phone or landline phone respectively coupled via one or more networks (24 and/or 26) to the remote appliance 12 (or 16, 18, or 19). The processor 11 can reside in one or more devices within system 10. For example, it can reside in devices 13, 28, or 30 as well as 12, 16, 18, or 19.

The processor 11 can be programmed to monitor the remote appliance for a predetermined set of activities indicative of availability or unavailability of the remote party when the communication device is attempting to communicate with the remote party, analyze the predetermined set of activities, and notify the communication device (most likely devices 28 or 30, but optionally 13) of the unavailability of the remote party if the predetermined set of activities match a stored set of activities. The stored set of activities can likewise be stored in a memory in any of the devices where the processor can reside (13, 28, 30, 12, 16, 18, or 19). The processor 11 can be further programmed to prevent a call or an alert at a communication device at the remote party (such as device 13) if the predetermined set of activities match the stored set of activities and enable a call or an alert at the remote party if the predetermined set of activities failed to match the stored set of activities. As noted above, the predetermined set of activities can include fast forwarding, rewinding, pausing, or changing channels on a set-top box or other appliance (12) or fast forwarding or rewinding on a video recording device or changing channels on a television tuner 14 as examples. The predetermined set of activities can also be activation of a function on the remote appliance implicitly indicating an unengaged user or explicitly indicating an engaged user. In this regard, the remote appliance can also be a remote controller 22 for any of the aforementioned appliances residing at a home, office or vicinity 20 of the remote party. As shown, the remote 22 can enter commands for fast forwarding, rewinding, playing and changing volume or channels. The remote 22 can also enable a user to enter explicit commands such as “DO NOT DISTURB” that would prevent the communication device 13 from ringing in one embodiment. Another explicit command can enable receipt of instant messaging messages on a computer 19 for example, but still no in-coming calls on the communication device 13. The commands can be communicated to the communication devices 28 or 30 of calling parties openly, but preferably the calling parties will either enter passwords or will be predetermined parties that are considered part of a friends or family group to provide added security and/or privacy.

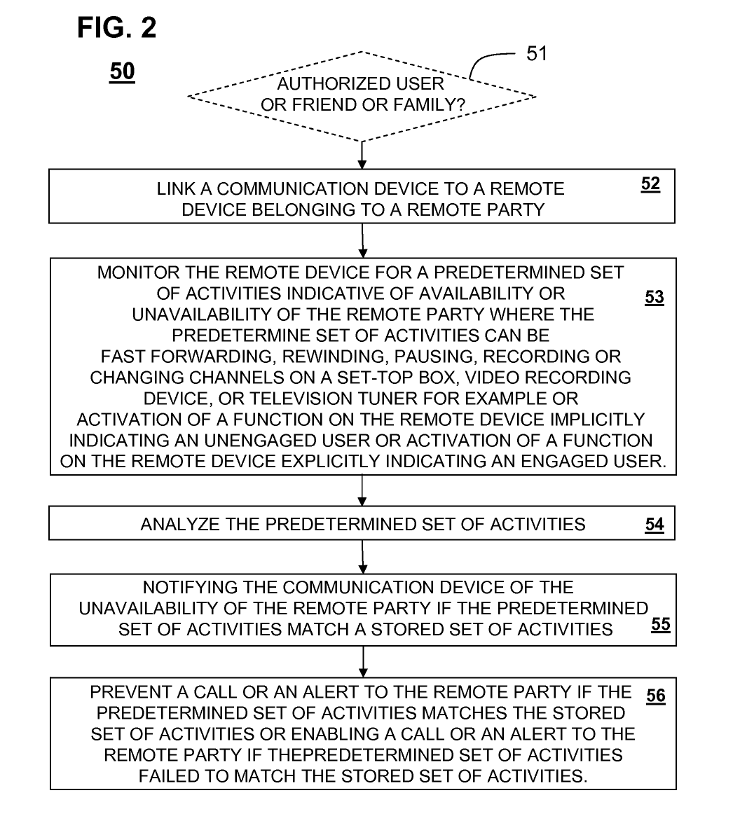

Referring to FIG. 2, a flow chart illustrating a method 50 of determining an availability of a remote party can include the step 52 of linking a communication device to a remote device belonging to the remote party, monitoring the remote device for a predetermined set of activities indicative of availability or unavailability of the remote party at step 53, analyzing the predetermined set of activities at step 54, and notifying the communication device of the unavailability of the remote party if the predetermined set of activities match a stored set of activities at step 55. The method 50 can optionally include the step of determining if the caller is an authorized user or friend or family at decision step 51 before a link is provided at step 52 or before enabling the monitoring step 53. The method 50 can also include the step 56 of preventing a call or an alert to the remote party if the predetermined set of activities matches the stored set of activities or enabling a call or an alert to the remote party if the predetermined set of activities failed to match the stored set of activities. The predetermined set of activities can include fast forwarding, rewinding, pausing, recording or changing channels on a set-top box or fast forwarding or rewinding or recording on a video recording device changing channels on a television tuner as examples. The predetermined set of activities can also include activation of a function on the remote device implicitly indicating an unengaged user or activation of a function on the remote device explicitly indicating an engaged user.

The steps 51-56 can be accomplished by a combination of devices in the system 10 such as the communication device 28 and the remote device 12 or other appliance, or can be interpreted to be performed by the communication device 28. That is, the communication device 28 may perform the analyzing of user type 51 using an internal table; the communication device 28 may perform the linking 52 by, for example, sending a message and determining receipt of a correct response; the communication device 28 may perform the monitoring 53 by, for example, sending a query message to the remote device 12 requesting the statutes of the activities and receiving a response; the communication device 28 may perform the analyzing 54 largely internally; the communication device 28 may perform the notifying 55 by making a determination of the unavailability of the remote party if the predetermined set of activities match a set of activities stored in the communication device 28 and presenting the result of that determination internally to other functions in the communication device 28 that may include the step of preventing the call or alert 56, and may include other action such as presenting a notice to the user of the communication device of the result of the determination.

The inverse is largely true also; that is the steps may be interpreted to be largely accomplished in a remote appliance. As just a couple of examples, the remote device 12 may perform the analyzing of user type 51 using an internal table after receiving a indication that the communication device is attempting a communication to the remote user; the remote device may perform the notifying 55 by making a determination of the unavailability of the remote party if the predetermined set of activities match a set of activities stored in the communication device 28 and sending an indication of the result in a message to the communication device 28; the remote device may perform the step of preventing the call or alert 56 by including in the notification of step 55 control parameters to prevent particular types of calls from the communication device, or may send controls to a communication device of the remote user that prevents it from receiving messages from the communication device 28.

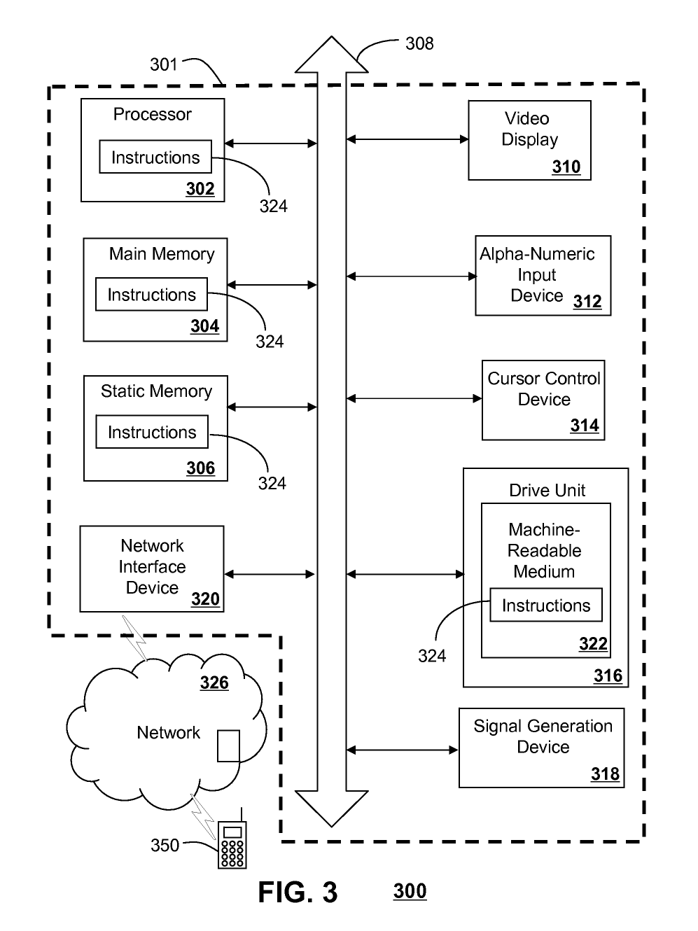

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 301 and a sending device 350 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 can include a controller or processor 302 (e.g., a central processing unit (CPU), a graphics processing unit (GPU, or both), a main memory 304 and a static memory 306, which communicate with each other via a bus 308. The computer system 300 may further include a presentation device such as a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control that can also serve as a presentation device) and a network interface device 320. Of course, in the embodiments disclosed, many of these items are optional.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of determining an availability of a remote party, comprising the steps of:
linking a communication device to a remote device associated with the remote party;
monitoring the remote device for a predetermined set of activities indicative of availability or unavailability of the remote party;
analyzing the predetermined set of activities; and
notifying the communication device of the unavailability of the remote party if the predetermined set of activities match a stored set of activities.

2. The method of claim 1, wherein the method further comprises the step of preventing a call or an alert to the remote party if the predetermined set of activities match the stored set of activities.

3. The method of claim 1, wherein the method further comprises the step of enabling a call or an alert to the remote party if the predetermined set of activities failed to match the stored set of activities.

4. The method of claim 1, wherein the predetermined set of activities comprises fast forwarding, rewinding, pausing, recording or changing channels on a set-top box.

5. The method of claim 1, wherein the predetermined set of activities comprises fast forwarding or rewinding or recording on a video recording device.

6. The method of claim 1, wherein the predetermined set of activities comprises changing channels on a television tuner.

7. The method of claim 1, wherein the predetermined set of activities comprises activation of a function on the remote device implicitly indicating an unengaged user.

8. The method of claim 1, wherein the predetermined set of activities comprises activation of a function on the remote device explicitly indicating an engaged user.

9. The method of claim 1, wherein the method further comprises linking the communication device to the remote device for the purpose of monitoring the remote device if the communication device is authorized to monitor the remote device.

10. A system of determining availability of a remote party, comprising:
a communication device enabled and authorized to monitor a remote appliance associated with the remote party; and
a processor coupled to the communication device or the remote appliance, wherein the processor is programmed to:
monitor the remote appliance for a predetermined set of activities indicative of availability or unavailability of the remote party when the communication device is attempting to communicate with the remote party;
analyze the predetermined set of activities; and
notify the communication device of the unavailability of the remote party if the predetermined set of activities match a stored set of activities.

11. The system of claim 10, wherein the processor is further programmed to prevent a call or an alert at a communication device at the remote party if the predetermined set of activities match the stored set of activities and enable a call or an alert at the remote party if the predetermined set of activities failed to match the stored set of activities.

12. The system of claim 10, wherein the predetermined set of activities comprises fast forwarding, rewinding, pausing, or changing channels on a set-top box.

13. The system of claim 10, wherein the predetermined set of activities comprises fast forwarding or rewinding on a video recording device or changing channels on a television tuner.

14. The system of claim 10, wherein the predetermined set of activities comprises activation of a function on the remote appliance implicitly indicating an unengaged user.

15. The system of claim 10, wherein the predetermined set of activities comprises activation of a function on the remote appliance explicitly indicating an engaged user.

16. An appliance, comprising:
a transceiver for communicating with a communication device; and
a processor coupled to the transceiver, wherein the processor is programmed to:
monitor the appliance for a predetermined set of activities indicative of availability or unavailability of a remote party associated with the appliance, the monitoring being performed when the communication device is attempting to communicate with the remote party;
analyze the predetermined set of activities; and
notify the communication device of the unavailability of the remote party associated with the appliance if the predetermined set of activities match a stored set of activities.

17. The appliance of claim 16, wherein the processor is further programmed to instruct or otherwise prevent a call or an alert on the communication device if the predetermined set of activities match the stored set of activities and enable a call or an alert at the communication device if the predetermined set of activities failed to match the stored set of activities.

18. The appliance of claim 16, wherein the predetermined set of activities comprises fast forwarding, rewinding, pausing, or changing channels on a set-top box or fast forwarding or rewinding on a video recording device or changing channels on a television tuner.

19. The appliance of claim 16, wherein the predetermined set of activities comprises activation of a function on the appliance implicitly indicating an unengaged user or activation of a function on the appliance explicitly indicating an engaged user.

20. The appliance of claim 16, wherein the appliance comprises a set-top box, a desktop computer, a laptop computer, a personal video recorder, a digital video recorder, a digital video player or recorder, a television tuner, or a remote controller for any of the aforementioned appliances.
